(19) United States
(12) Patent Application Publication
(10) Pub. No.: US 2022/0199306 A1
(43) Pub. Date: Jun. 23, 2022

(54) TRANSFORMER AND BOBBIN THEREOF

(71) Applicant: Chicony Power Technology Co., Ltd., New Taipei City (TW)

(72) Inventors: Po-Chien Chou, New Taipei City (TW); Che-Shih Lin, New Taipei City (TW); Yi-Wei Su, New Taipei City (TW)

(21) Appl. No.: 17/301,211

(22) Filed: Mar. 29, 2021

(30) Foreign Application Priority Data
Dec. 18, 2020 (TW) 109145162

(51) Int. Cl. H01F 5/04; H01F 27/32; H01F 27/30

(52) U.S. Cl. CPC H01F 5/04; H01F 2005/043; H01F 27/306; H01F 27/325

(57) ABSTRACT

A transformer includes a bobbin. The bobbin includes a main body, a connection member, and a terminal base. The main body is wound by a coil. Two sides of the connection member are respectively connected to the main body and the terminal base. A plurality of connection terminals of the coil extend to the terminal base through a wire trough of the main body and are connected to pins of the terminal base. The connection member is cut off by automated machining, and the terminal base is mounted on a surface of a housing of the transformer, and no pin is disposed on the housing. Hence, the overall size of the transformer is effectively reduced.

### CROSS-REFERENCE TO RELATED APPLICATION

This non-provisional application claims priority under 35 U.S.C. § 119(a) to Patent Application No. 109145162 filed in Taiwan, R.O.C. on Dec. 18, 2020, the entire contents of which are hereby incorporated by reference.

### BACKGROUND

### Technical Field

The disclosure relates to a transformer, especially a transformer having a bobbin for automatically assembling.

### Related Art

A transformer is an electronic assembly commonly used in an electronic product. The transformer converts a driving voltage in an electronic circuit. A general transformer includes a housing, a bobbin in the housing, a primary side coil and a secondary side coil that are wound around the bobbin, and a magnetic core set covering the bobbin and the coils. An appearance of the transformer is mainly presented by a two-piece element including the housing and the bobbin. The bobbin has a plurality of pins. The housing has a plurality of pins. The primary side coil and the secondary side coil are located on the bobbin. A wire of the primary side coil can be wound on each of the pins of the bobbin through automated assembling. However, a wire of the secondary side coil needs to be manually pulled out of the bobbin and wound around each of the pins of the housing and then soldered. It means the wire-winding and soldering procedures cannot be automatically produced.

### SUMMARY

In view of this, according to some embodiments, a bobbin adapted to be wound by a coil, the bobbin includes a main body, a connection member, and a terminal base. The main body includes an extension portion and a wire trough. One side of the connection member is connected to the extension portion. The connection member has a cutting portion. The terminal base includes a pin. The terminal base is connected to the other side of the connection member. A connection terminal of the coil extends to the terminal base through the wire trough and is connected to the pin.

In some embodiments, the main body, the connection member, and the terminal base is integrated in one piece made of a same material. The connection member and the terminal base are arranged transversely on a side edge of the main body along a first axis.

In some embodiments, the connection member has two cutting portions, one of the cutting portions is disposed adjacent to the main body, and the other of the cutting portions is disposed adjacent to the terminal base.

In some embodiments, the bobbin further includes a plurality of connection members. One sides of the plurality of connection members are correspondingly connected to two sides of the extension portion, and the other sides of the plurality of connection members are respectively connected to two sides of the terminal base. The terminal base includes two pins, whereby, the number of the connection terminal of the coil is two, the two pins are adapted to be respectively connected to the two connection terminals of the coil.

In some embodiments, the extension portion has a plurality of protrusions, and the main body has a wire outlet between the plurality of protrusions. The plurality of connection terminals of the coil extend between the connection members via the wire outlet.

In some embodiments, the distance between the plurality of protrusions is less than the distance between the connection members.

In some embodiments, the extension portion has a first fillet. The terminal base has a second fillet. The first fillet is located at the wire outlet. The first fillet and the second fillet are adapted to respectively be for contact with the coil.

In some embodiments, the number of the extension portion of the main body is two, the number of the wire troughs of the main body is two, and the main body has the two extension portions and the two wire troughs. The number of the connection terminal of the coil is four. The coil has the four connection terminals. The bobbin includes two terminal bases. Each of the terminal bases includes two pins. The four connection terminals correspondingly extend out through the wire troughs and are adapted to be correspondingly connected to the two pins of the terminal bases.

In some embodiments, a transformer is provided, including a housing, a coil, and a bobbin. The bobbin includes a main body, a connection member, and a terminal base, where the main body is wound by the coil and located in the housing, the main body has an extension portion and a wire trough. One side of the connection member is connected to the extension portion. The connection member has a cutting portion. The terminal base includes a pin. The terminal base is connected to the other side of the connection member. A connection terminal of the coil extends to the terminal base through the wire trough and is connected to the pin. The connection member and the terminal base are located outside the housing.

In some embodiments, a transformer is provided, including a housing, a coil, and a bobbin. The housing includes an assembling portion. The bobbin includes a main body and a terminal base. The main body is wound by the coil and located in the housing. The main body has an extension portion and a wire trough. The terminal base includes a pin. A connection terminal of the coil extends to the terminal base through the wire trough and is connected to the pin. The terminal base includes an engaging portion engaged with the assembling portion. One of the extension portion and the terminal base has at least one fracture marking portion.

In some embodiments, the fracture marking portion has a cutting plane or a cutting line.

In some embodiments, one of the assembling portion and the engaging portion has an engaging member, and the terminal base is vertically arranged on a surface of the housing along a second axis.

In some embodiments, the housing has a terminal fixing member. The terminal fixing member is fixed to each of the pins.

In some embodiments, the extension portion has one or more fracture marking portions. The terminal base has a one or more fracture marking portions.

In some embodiments, the terminal base includes two pins which are connected to two connection terminals in a one-to-one manner.

In some embodiments, the number of the extension portion of the main body is two, the number of the wire troughs of the main body is two, and the main body has the two extension portions and the two wire troughs. The number of the connection terminal of the coil is four, and the coil has the four connection terminals. The bobbin includes two terminal bases. Each of the terminal bases includes two pins. The four connection terminals correspondingly extend out through the wire troughs and are adapted to be correspondingly connected to the two pins of the terminal bases.

Based on the above, according to some embodiments, after the connection member is removed through automated machining, the terminal base is mounted on the surface of the housing. An appearance of the transformer is mainly presented by a three-piece element: the housing, the bobbin, and the terminal base. Pins are provided on the terminal base for soldering of wires, and the housing has no pins, which effectively reduces the overall size of the transformer, thus achieving miniaturization, weight reduction, and portability of the transformer, and reducing a manufacturing time and labor costs of the transformer. Secondly, according to some embodiments, the connection member between the main body of the bobbin and the terminal base that can be cut off through automated machining effectively increases efficiency of automated machining and a yield of the transformer.

### BRIEF DESCRIPTION OF THE DRAWINGS

FIG. 1 illustrates a schematic exploded view of a transformer according to some embodiments, showing a state in which a bobbin is not wound by a coil.

FIG. 2 illustrates a schematic diagram of an appearance of the transformer of FIG. 1 viewed from the front according to some embodiments, showing a state in which the bobbin is not wound by the coil.

FIG. 3 illustrates a schematic diagram of the appearance of the transformer viewed from the back according to some embodiments, showing a state in which the bobbin is not wound by the coil.

FIG. 4 illustrates a schematic diagram of the appearance of the transformer of FIG. 2 that has been flipped by 180 degrees according to some embodiments, showing a state in which the bobbin is not wound by the coil.

FIG. 5 illustrates a schematic top view of the bobbin according to some embodiments, showing a state in which the bobbin is not wound by the coil.

FIG. 6 illustrates a schematic diagram of an appearance of the bobbin according to some embodiments, showing a state in which the bobbin is wound by the coil and no solder is applied.

FIG. 7 illustrates a schematic diagram of the appearance of the bobbin to which a magnetic core set is mounted according to some embodiments.

FIG. 8 illustrates a schematic diagram of the appearance of the bobbin to which a housing is mounted according to some embodiments.

FIG. 9 illustrates a schematic diagram of an appearance of a transformer fixed by an adhesive tape according to some embodiments.

FIG. 10 illustrates a schematic top view of a transformer according to some embodiments, showing a state in which a connection member is not removed.

FIG. 11 illustrates a schematic top view of the transformer according to some embodiments, showing a state in which the connection member is removed.

FIG. 12 illustrates a partial schematic side view of the transformer according to some embodiments, showing a state in which the connection member is not removed.

FIG. 13 illustrates a partial schematic side view of a transformer according to some embodiments, showing a state in which a connection member is removed.

FIG. 14 illustrates a schematic side view of a transformer according to some embodiments, showing a state in which a terminal base is assembled on a housing.

FIG. 15 illustrates a schematic diagram of an appearance of a transformer according to some embodiments, showing a state in which a terminal base is assembled on a housing, where an extension portion and the terminal base have a plurality of fracture marking portions.

FIG. 16 illustrates a schematic top view of a transformer according to some embodiments, showing a state in which a single connection member is removed.

FIG. 17 illustrates a schematic diagram of an appearance of a transformer shown in FIG. 16, showing a state in which an extension portion has a single fracture marking portion.

FIG. 18 illustrates a schematic diagram of an appearance of a transformer according to some embodiments, showing a state in which a housing has a terminal fixing member.

FIG. 19 illustrates a schematic diagram of an appearance of another transformer according to some embodiments.

FIG. 20 illustrates a partial schematic side view of the transformer according to some embodiments, showing a state in which a connection member has a cutting portion.

FIG. 21 illustrates a partial schematic side view of the transformer according to some embodiments, showing a state in which an assembling portion and an engaging portion both have an engaging member.

FIG. 22 illustrates a partial schematic side view of the transformer according to some embodiments, showing a state in which one of the assembling portion and the engaging portion has an engaging member.

### DETAILED DESCRIPTION

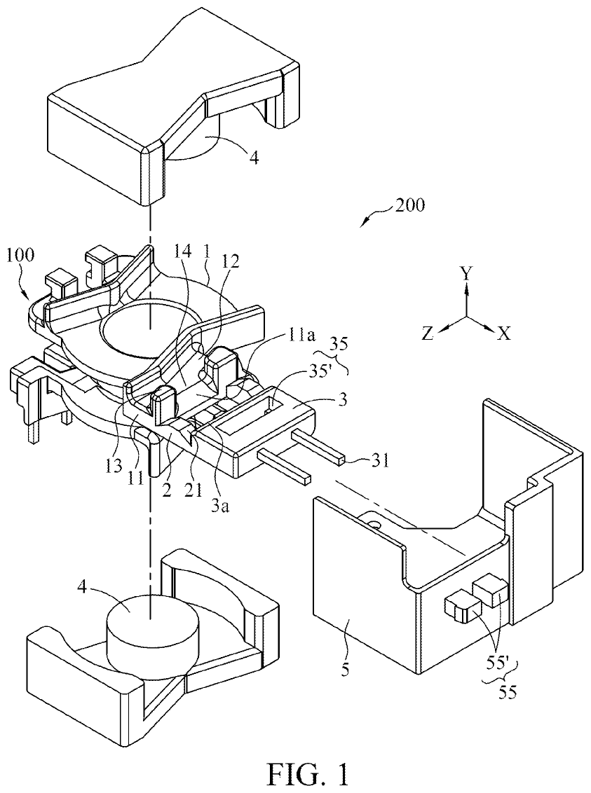

Referring to FIG. 1, FIG. 1 is a schematic exploded view of a transformer 200, in which a bobbin 100 is not wound by a coil 9. In some embodiments, the bobbin 100 includes a main body 1, a connection member 2, and a terminal base 3.

The main body 1 has an extension portion 11 and a wire trough 12.

One side of the connection member 2 is connected to the extension portion 11. The connection member 2 has a cutting portion 21.

The terminal base 3 includes one pin 31 (not shown; only one pin 31 of a plurality of pins 31 shown in FIG. 1 is left). The terminal base 3 is connected to the other side of the connection member 2.

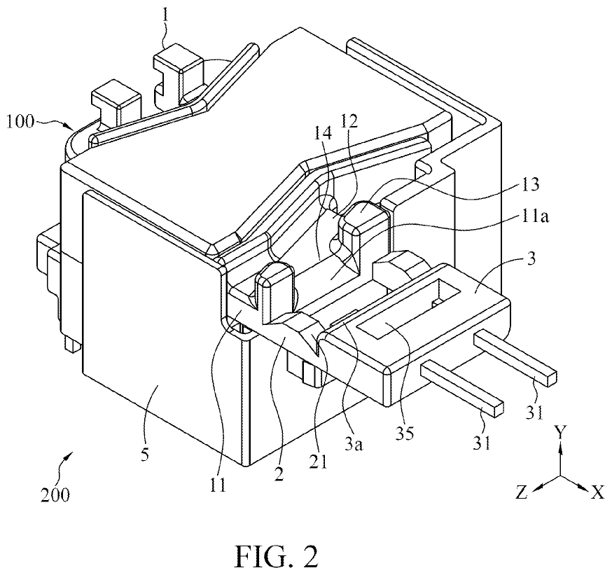

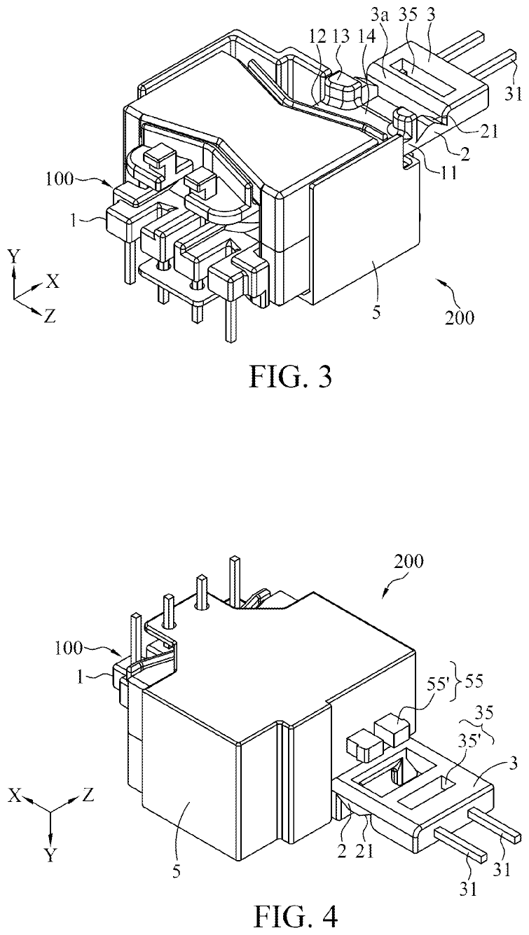

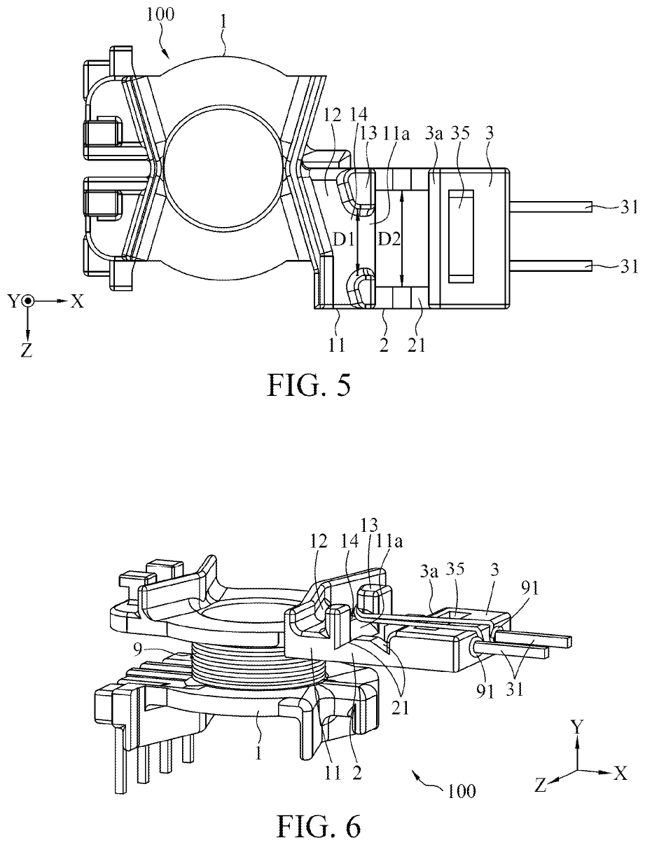

Referring to FIG. 1 to FIG. 6 together, FIG. 2 is a schematic diagram of an appearance of the transformer 200 of FIG. 1 when viewed from the front, in which the bobbin 100 is not wound by the coil 9. FIG. 3 is a schematic diagram of the appearance of the transformer 200 when viewed from the back, in which the bobbin 100 is not wound by the coil 9. FIG. 4 is a schematic diagram of the appearance of the transformer 200 of FIG. 2 that has been flipped 180 degrees, in which the bobbin 100 is not wound by the coil 9. FIG. 5 is a schematic top view of the bobbin 100, in which the bobbin 100 is not wound by the coil 9. FIG. 6 is a schematic diagram of an appearance of the bobbin 100, in which the bobbin 100 is wound by the coil 9, and no solder 92 is applied. In some embodiments, one side of the main body 1 has one extension portion 11 and one wire trough 12. The main body 1 is wound by a coil 9 (which is shown in FIG. 6). One connection terminal 91 of the coil 9 (not shown, but only one connection terminal 91 of a plurality of connection terminals 91 shown in FIG. 6 may be left) extends to the terminal base 3 through the wire trough 12 and is connected to one pin 31 (or a plurality of pins 31). The present invention is not limited thereto. In some embodiments, the coil 9 (which is shown in FIG. 6) has two connection terminals 91. A number and a sequence of coils 9 wound on the main body 1 are not limited. A primary side coil 9 is wound on the main body 1 to a left terminal in FIG. 6, and a secondary side coil 9 is wound on the main body 1 to pins 31 on the terminal base 3 on the right side of FIG. 6. The secondary side coil 9 is described below by using the coil 9. The bobbin 100 includes one terminal base 3. The terminal base 3 includes two pins 31. The connection terminals 91 of the coil 9 respectively extend out through the wire trough 12 and are connected to the pins 31 in a one-to-one manner.

Referring to FIG. 1, FIG. 5, and FIG. 6 together, when a plurality of connection terminals 91 of the coil 9 are arranged to be wound around the wire trough 12 and threaded out of the wire trough 12, the plurality of connection terminals 91 span a surface of the terminal base 3 to a side end of the terminal base 3, so that each of the connection terminals 91 is fixed to each of the pins 31 at the side end of the terminal base 3 through winding, and then a solder 92 is applied to a joint between each of the connection terminals 91 and each of the pins 31 for fixing (which is shown in FIG. 14).

Referring to FIG. 1 and FIG. 6 together, in some embodiments, the connection member 2 and the terminal base 3 are substantially perpendicular to the main body 1. The main body 1, the connection member 2, and the terminal base 3 are an integrated member. The main body 1, the connection member 2, and the terminal base 3 are formed through injection molding with the same material (for example but not limited to bakelite). The present invention is not limited thereto. In some embodiments, the main body 1, the connection member 2, and the terminal base 3 may be formed through injection molding (co-injection molding) with a plurality of materials.

Referring to FIG. 1 and FIG. 6 together, in some embodiments, the connection member 2 and the terminal base 3 are arranged transversely on a side edge of the main body 1 along a first axis X. The first axis X is an axis X of a three-dimensional coordinate system, a second axis Y is an axis Y of the three-dimensional coordinate system, and a third axis Z is an axis Z of the three-dimensional coordinate system. The first axis X, the second axis Y, and the third axis Z are substantially perpendicular to each other. An angle between the first axis X and the second axis Y is 90 degrees. However, the present invention is not limited thereto. In some embodiments, the angle between the first axis X and the second axis Y may be any angle from 75 degrees to 125 degrees.

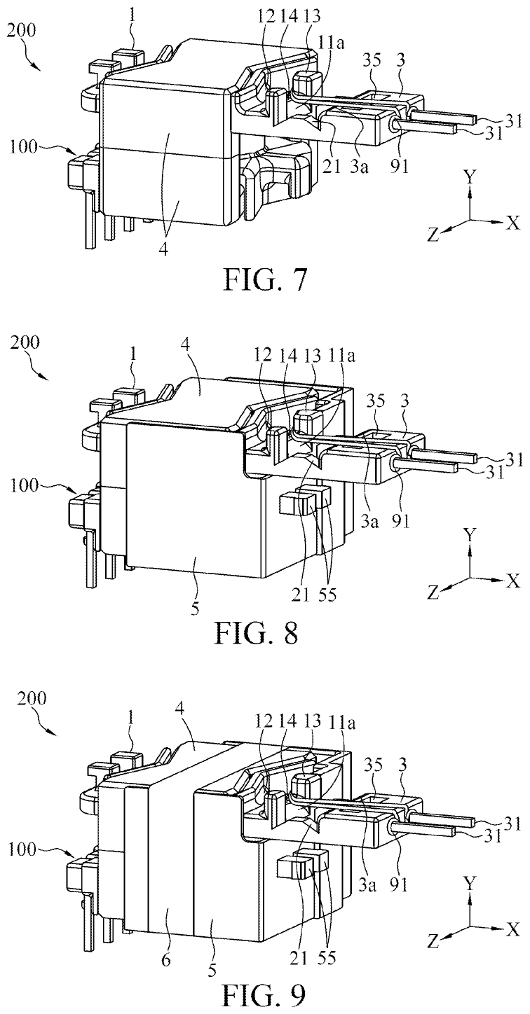

Referring to FIG. 7 to FIG. 9 together, FIG. 7 is a schematic diagram of the appearance of the bobbin 100 to which a magnetic core set 4 is mounted. FIG. 8 is a schematic diagram of the appearance of the bobbin 100 to which a housing 5 is mounted. FIG. 9 is a schematic diagram of an appearance of a transformer 200 fixed by an adhesive tape 6. In some embodiments, after the solder 92 is applied to a joint between each of connection terminals 91 and each of pins 31 of the bobbin 100, the magnetic core set 4 is mounted on the main body 1, and then the housing 5 is assembled outside the main body 1 and the magnetic core set 4, and then the adhesive tape 6 is wound around the housing 5 and the magnetic core set 4 for fixing. Alternatively, the housing 5 and the magnetic core set 4 may be glued through glue.

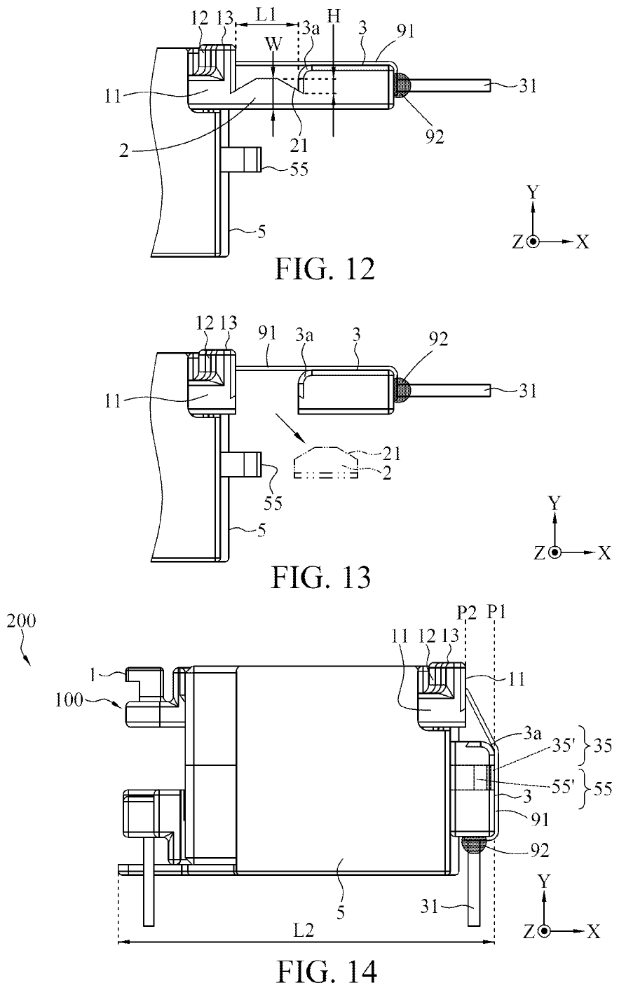

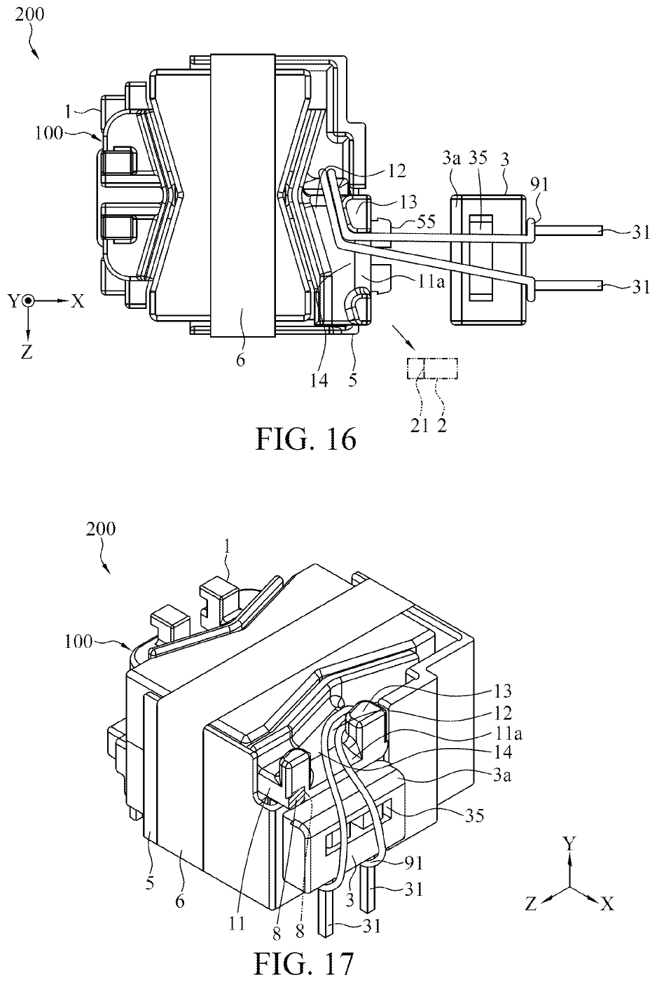

Referring to FIG. 1, FIG. 6, and FIG. 12 together, FIG. 12 is a partial schematic side view of the transformer 200, showing a state in which a connection member 2 is not removed. In some embodiments, the connection member 2 has two cutting portions 21 (or may have one cutting portion 21 shown in FIG. 16). One of the cutting portions 21 is disposed adjacent to the main body 1, and the other of the cutting portions 21 is disposed adjacent to the terminal base 3. In some embodiments, the cutting portion 21 of the connection member 2 is a cutting groove 21 (the cutting groove 21 is used as an example below, which is given the same reference numeral as the cutting portion 21). The cutting groove 21 is formed above the connection member 2 for automated machining tools to cut off the connection members 2. The present invention is not limited thereto. In some embodiments, the cutting groove 21 may be formed below the connection member 2 for automated machining tools to cut off the connection members 2.

Referring to FIG. 1, FIG. 6, and FIG. 12 together, in some embodiments, a depth H of the cutting groove 21 is depends on a material of the connection member 2, a thickness W of the connection member 2, and a length L1 of the connection member 2. In some embodiments, for example, during fabrication of the connection member 2 by using bakelite, because the cutting groove 21 is a V-shaped groove, it is convenient to cut off the connection member 2 through automated machining. Disposing, between the main body 1 and the terminal base 3, the connection member 2 that facilitates cutting off through automated machining increases efficiency of automated machining by at least 30% and a yield of the transformer 200 after machining.

Referring to FIG. 1 and FIG. 6 together, in some embodiments, the extension portion 11 is a bump protruding transversely from the side edge of the main body 1 along the axis X. The extension portion 11 has a plurality of protrusions 13. Each of the protrusions 13 protrudes on a surface of the extension portion 11 along the axis Y. Peripheral edges of each of the protrusions 13 are fillets for smooth contact by the connection terminal 91, thus avoiding wear and fracture.

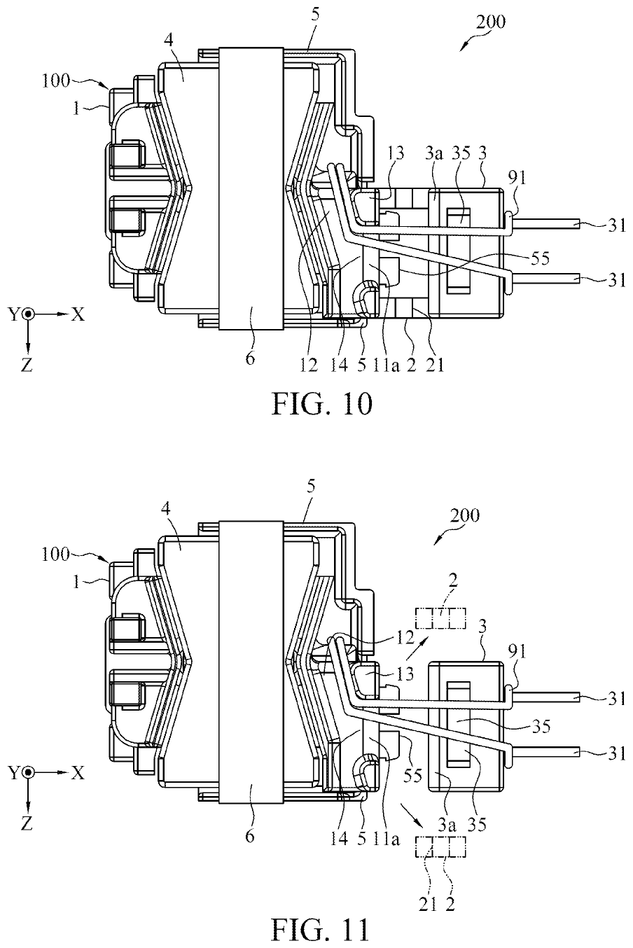

Referring to FIG. 5, FIG. 6, FIG. 10, and FIG. 11 together, FIG. 10 is a schematic top view of the transformer 200, showing a state in which the connection member 2 is not removed. FIG. 11 is a schematic top view of the transformer 200, showing a state in which the connection member 2 is removed. In some embodiments, the main body 1 has a wire outlet 14. The wire outlet 14 is located between a plurality of protrusions 13. A distance D1 (that is, a width of the wire outlet 14) between the plurality of protrusions 13 is less than a distance D2 (which is shown in FIG. 5) between the connection members 2. A plurality of connection terminals 91 of the coil 9 are threaded out through the wire outlet 14 and extend between the connection members 2 (which is shown in FIG. 10). From the top view of the transformer 200 shown in FIG. 10, the connection terminals 91 do not overlap the connection members 2.

Referring to FIG. 6 to FIG. 9 together, in some embodiments, an embodiment of a transformer 200 is provided. The transformer 200 includes a housing 5 and the above bobbin 100. The bobbin 100 includes a main body 1, a connection member 2, and a terminal base 3. The main body 1 is wound by a coil 9 and located in the housing 5. The main body 1 has an extension portion 11 and a wire trough 12. One side of the connection member 2 is connected to the extension portion 11. The connection member 2 has a cutting portion 21. The terminal base 3 includes a plurality of pins 31. The terminal base 3 is connected to the other side of the connection member 2. A plurality of connection terminals 91 of the coil 9 extend to the terminal base 3 through the wire trough 12 and are connected to the pins 31. The connection member 2 and the terminal base 3 are located outside the housing 5. The connection member 2 has two cutting portions 21. One of the cutting portions 21 is disposed adjacent to the main body 1, and the other of the cutting portions 21 is disposed adjacent to the terminal base 3. The transformer 200 further includes a plurality of connection members 2. One side of each of the connection members 2 is connected to two sides of the extension portion 11, and the other side of each of the connection members 2 is connected to two sides of the terminal base 3. In some embodiments, a material of the housing 5 is, for example, but not limited to, plastic or bakelite.

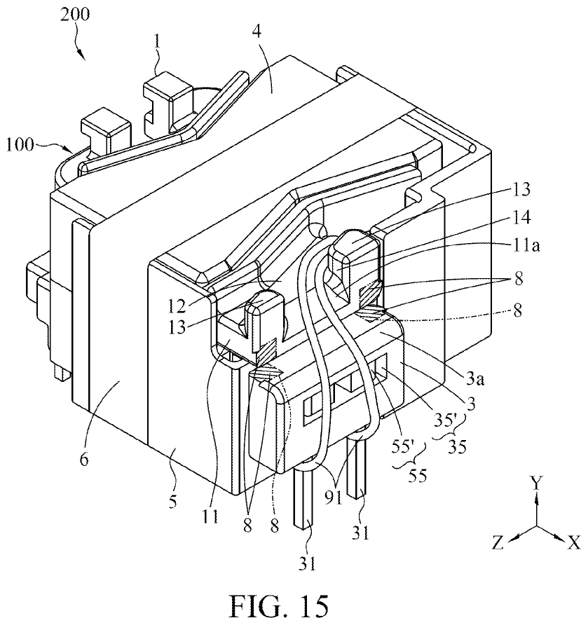

Referring to FIG. 12 to FIG. 15 together, FIG. 13 is a partial schematic side view of the transformer 200, showing a state in which a connection member 2 is removed. FIG. 14 is a schematic side view of the transformer 200, showing a state in which a terminal base 3 is assembled on a housing 5. FIG. 15 is a schematic diagram of an appearance of the transformer 200, showing a state in which the terminal base 3 is assembled on the housing 5, where an extension portion 11 and the terminal base 3 have a plurality of fracture marking portions 8. In some embodiments, an embodiment of a transformer 200 is provided. The transformer 200 includes a housing 5 and the above bobbin 100. The housing 5 includes an assembling portion 55. The bobbin 100 includes a main body 1 and a terminal base 3. The main body 1 is wound by a coil 9 and located in the housing 5. The main body 1 has an extension portion 11 and a wire trough 12. The terminal base 3 includes a plurality of pins 31. A plurality of connection terminals 91 of the coil 9 extend to the terminal base 3 through the wire trough 12 and are connected to the pins 31. The terminal base 3 includes an engaging portion 35.

When the engaging portion 35 of the terminal base 3 is engaged with the assembling portion 55 of the housing 5, the terminal base 3 is vertically arranged on a surface of the housing 5 along a second axis Y (which is shown in FIG. 15). Viewed from the appearance of the transformer 200, one of the extension portion 11 and the terminal base 3 has at least one fracture marking portion 8 (as shown in FIG. 17, the extension portion 11 has one fracture marking portion 8, and details are described later).

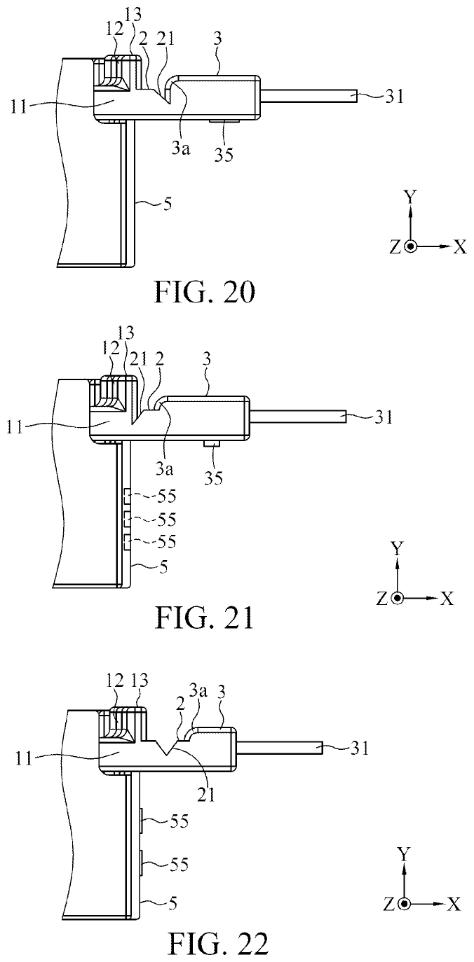

In some embodiments, one of the assembling portion 55 and the engaging portion 35 has an engaging member. The engaging member may be a hook 55′ (which is shown in FIG. 12) of the assembling portion 55 for snapping the assembling portion 55 into the engaging portion 35. The present invention is not limited thereto. In some embodiments, the engaging member may be a hook (not shown) of the engaging portion 35 for snapping the assembling portion 55 into the engaging portion 35. In some embodiments, the engaging member is a recess 55 and a bump 35 (a concave-convex structure shown in FIG. 21, and the concave-convex structure may have various shapes, such as a circle, a triangle, a square, or a semicircle) for snap-fitting the assembling portion 55 to the engaging portion 35. In some embodiments, the engaging member is a sticking member 35 or a sticking member 55 (which is shown in FIG. 20 and FIG. 22) for sticking the assembling portion 55 to the engaging portion 35. In some embodiments, the engaging member engages the assembling portion 55 with the engaging portion 35 through welding.

In some embodiments, the engaging portion 35 has the sticking member 35 (as shown in FIG. 20, the sticking member 35 is given the same reference numeral as the engaging portion 35). When the engaging portion 35 of the terminal base 3 is engaged with the housing 5 (not shown, for example, the vertical terminal base 3 shown in FIG. 14 is mounted on the surface of the housing 5), the terminal base 3 is stuck on the surface of the housing 5 by means of the sticking member 35, so that the terminal base 3 is fixed to the housing 5. The terminal base 3 may be stuck to any position on the surface of the housing 5 as required.

In some embodiments, the assembling portion 55 of the housing 5 may have a plurality of recesses 55 (as shown in FIG. 21, the recesses 55 is given the same reference numeral as the assembling portion 55). The recesses 55 are arranged vertically (as shown in FIG. 21, arranged along the axis Y) or horizontally (not shown) side by side at a predetermined interval. The engaging portion 35 of the terminal base 3 has a bump 35 (as shown in FIG. 21, the bump 35 is given the same reference numeral as the engaging portion 35). The bump 35 may be selectively snap-fitted into one of the plurality of recesses 55. The bump 35 may be snap-fitted into a recess 55 at a relatively high or low position arranged along the axis Y on the surface of the housing 5 as required, or the bump 35 may be snap-fitted into a recess 55 (not shown, for example, one of the plurality of recesses 55 disposed along the axis Z shown in FIG. 21) at a position on the right or the left of the surface of the housing 5.

In some embodiments, the assembling portion 55 has a plurality of sticking members 55 (as shown in FIG. 22, the sticking member 55 is given the same reference numeral as the assembling portion 55) at different positions. When the terminal base 3 is engaged with the housing 5 (not shown, for example, the vertical terminal base 3 shown in FIG. 14 is mounted on the surface of the housing 5), the terminal base 3 is selectively stuck on the sticking member 55 at different positions, so that the terminal base 3 is stuck to any position on the surface of the housing 5 as required.

Referring to FIG. 1, FIG. 4, and FIG. 14 together, in some embodiments, the assembling portion 55 has a plurality of hooks 55′. The engaging portion 35 has a hole 35′. The plurality of hooks 55′ are snapped into the hole 35′ (which is shown in FIG. 14 and FIG. 15). The present invention is not limited thereto. In some embodiments, the engaging portion 35 may not have the hole 35′, and the assembling portion is directly snapped into outer walls on two sides of the terminal base 3 through the plurality of hooks 55′. In some embodiments, the hook 55′ and the hole 35′ are transposed. The assembling portion 55 may have a hole 35′ (not shown), and the engaging portion 35 has a hook 55′ (not shown). The hook 55′ is snapped into the hole 35′.

In some embodiments, the assembling portion 55 has a hook 55′. If the hooks 55′ needs to be used at different positions on a side wall of the housing 5, only a position of a mold insert (not shown) or a slider (not shown) needs to be adjusted without a need to redevelop a new mold (not shown) to manufacture various housings 5. After injection molding, the hook 55′ is formed in the mold insert (not shown) or the slider (not shown) at different positions, so that the hooks 55′ can be used at different positions on the housing 5.

In some embodiments, positions of the engaging portion 35 and the assembling portion 55 may be adjusted as required. For example, the engaging portion 35 is disposed at any position on the surface of the terminal base 3, or the assembling portion 55 is disposed at any position on the surface of the housing 5. In some embodiments, the position of the assembling portion 55 on the side wall of the housing 5 may be adjusted as required. For example, as shown in FIG. 1, the position is adjusted upward along the axis Y, so that the terminal base 3 is located at a relatively high position on the side wall of the housing 5 after the engaging portion 35 of the terminal base 3 is engaged with the assembling portion 55 (which is shown in FIG. 14), which prevents a solder 92 at the winding position between each of the connection terminals 91 of the secondary side coil 9 and the pin 31 from exceeding a bottom of the housing 5 (the bottom of the housing 5 is a lowest part of the housing 5 shown in FIG. 14), so that the transformer 200 can be stably soldered on a circuit board (not shown).

In some embodiments, each of the connection terminals 91 of the secondary side coil 9 is wound with each of the pins 31 of the terminal base 3. Then, the solder 92 is soldered at the winding position, so that the connection terminal 91 has a fixed length and is disposed on the terminal base 3 (which is shown in FIG. 12). The length of the connection terminal 91 is proportional to a length L1 of the connection member 2. A larger length L1 of the connection member 2 leads to a larger length of the connection terminal 91. By adjusting the length L1 of the connection member 2, a length of a tie line of a tail section of the winding of the connection terminal 91 may be controlled during automated machining.

In some embodiments, each of the connection terminals 91 of the secondary side coil 9 is first soldered to each of the pins 31 on the terminal base 3, and then the connection member 2 is cut off to separate the main body 1 from the terminal base 3. The two-point-connected connection member 2 shown in FIG. 13 is removed, and the terminal base 3 is fixed transverse to the side edge of the housing 5 with the terminal base 3 being connected by the connection terminal 91. Then, after the automated machining tool rotates the terminal base 3 by 90 degrees from the horizontal position along the axis X (the first axis X arrangement position), which is shown in FIG. 13, the terminal base 3 is at an upright position along the axis Y (the second axis Y arrangement position) shown in FIG. 14 and is mounted on the surface of the housing 5, so that the engaging portion 35 of the terminal base 3 is engaged with the assembling portion 55 of the housing 5.

In some embodiments, after the vertical terminal base 3 is mounted on the surface of the housing 5, the solder 92 at the bottom of the terminal base 3 shown in FIG. 14 does not protrude from the bottom of the housing 5 (the bottom of the housing 5 shown in FIG. 14), which prevents the solder 92 at the winding position between each of the connection terminals 91 of the secondary side coil 9 and the pin 31 from exceeding the bottom of the housing 5, so that the transformer 200 is stably soldered on the circuit board (not shown).

Generally, a pin is provided on a housing of a transformer for traditional automated machining. A larger length and volume of the housing are required to dispose the pin. As a result, the transformer has a larger total length and volume. In some embodiments of the present invention, pins 31 are provided on the terminal base 3, but the housing 5 does not need the pins 31. As shown in FIG. 14, after the vertical terminal base 3 is mounted on the surface of the housing 5 through automated machining, the length of the housing 5 and the overall length L2 of the transformer 200 are effectively reduced, thus achieving miniaturization, weight reduction, and portability of the transformer 200, reducing a manufacturing time and labor costs of the transformer 200, and effectively reducing a space occupied for mounting electronic products.

In some embodiments, after the vertical terminal base 3 is mounted on the surface of the housing 5, a first outer diameter P1 of the terminal base 3 is at a distance from a second outer diameter P2 of the extension portion 11 (as shown in FIG. 14, it is assumed that the first outer diameter P1 and the second outer diameter P2 fall at two different positions on the axis X). The present invention is not limited thereto. In some embodiments, a thickness of the terminal base 3 may be thinner as required. After the vertical terminal base 3 is mounted on the surface of the housing 5, the first outer diameter P1 marked on the outer side of the terminal base 3 shown in FIG. 14 may be approximate to the second outer diameter P2 marked on the outer side of the extension portion 11 (as shown in FIG. 14, it is assumed that the first outer diameter P1 and the second outer diameter P2 fall at two points on the axis X close to each other), for example (but the present invention is not limited thereto), the first outer diameter P1 marked on the outer side of the terminal base 3 shown in FIG. 14 is at the same position as the second outer diameter P2 marked on the outer side of the extension position 11, which means that the first outer diameter P1 and the second outer diameter P2 are aligned on the same horizontal plane on the axis Y, which is shown in FIG. 14 (as shown in FIG. 14, it is assumed that the first outer diameter P1 and the second outer diameter P2 fall at the same position of the same point on the axis X), effectively reducing the overall length L2 of the transformer 200.

In some embodiments, if the terminal base 3 is assembled at a lower position on the side wall of the housing 5 (not shown, for example, the terminal base 3 shown in FIG. 14 is located at a lower position on the housing 5), the secondary side coil 9 is likely to be pulled to fracture. However, by virtue of position adjustability of the assembling portion 55 on the side wall of the housing 5, the assembling portion 55 is fixed at a proper position on the side wall of the housing 5, which can prevent the secondary side coil 9 from being pulled to fracture in that the terminal base 3 is assembled at a lower position on the side wall of the housing 5. The terminal base 3 can be assembled at different positions on the side wall of the housing 5, so that the bobbin 100 can be applicable to products of different models (not shown), and the same bobbin 100 can be shared. In addition, the pins 31 of the terminal base 3 of the bobbin 100 are soldered on a suitable circuit board (not shown) after being adjusted to a proper height. The terminal base 3 can be assembled at different positions on the side wall of the housing 5, so that the pins 31 on the terminal base 3 can match configurations of electronic parts on the circuit board.

In some embodiments, an exterior of the extension portion 11 has a plurality of fracture marking portions 8 (shown in FIG. 15), and an exterior of the terminal base 3 has a plurality of fracture marking portions 8 (shown in FIG. 15). The fracture marking portion 8 is a cutting plane 8 or a cutting line 8 (the cutting plane 8 or the cutting line 8 is used as an example for description below and is given the same reference numeral as the fracture marking portion 8). The cutting plane 8 is a slash area shown in FIG. 15, but an actual transformer 200 product does not have the slash. The cutting line 8 is a one-point line at an edge of the slash area shown in FIG. 15, but an actual transformer 200 product does not have the one-point line. An exterior of the actual transformer 200 may have only the cutting plane 8, the cutting line 8, or other traces.

In some embodiments, a plurality of connection members 2 are respectively connected to two sides of the extension portion 11 and two sides of the terminal base 3. Each of the connection members 2 has two cutting portions 21 respectively disposed adjacent to the main body 1 and the terminal base 3. After the automated machining tool cuts off the cutting portions 21 of the connection members 2, a plurality of cutting planes 8 or cutting lines 8 are formed on the exterior of the extension portion 11, and a plurality of cutting planes 8 or cutting lines 8 are formed on the exterior of the terminal base 3. The present invention is not limited thereto. In some embodiments, if no cutting portion 21 is provided on the connection member 2, after the connection member 2 is cut off, a fracture marking portion 8 may be formed on the exterior of the terminal base 3 and/or the exterior of the extension portion 11.

In some embodiments, the bobbin 100 includes a connection member 2 (shown in FIG. 16). One side of the connection member 2 is connected to the extension portion 11, and the other side of the connection member 2 is connected to the terminal base 3. The main body 1 is connected to the terminal base 3 by means of one connection member 2. In some embodiments, the exterior of the extension portion 11 has a fracture marking portion 8 (shown in FIG. 17), and the exterior of the terminal base 3 has a fracture marking portion 8. After a cutting portion 21 of a used connection member 2 is cut off by the automated machining tool, a fracture marking portion 8 is formed on the exterior of the extension portion 11, and a fracture marking portion 8 is formed on the exterior of the extension portion 11. The present invention is not limited thereto. In some embodiments, a cutting portion 21 of a connection member 2 may be disposed adjacent to the terminal base 3. After the connection member 2 is cut off, a fracture marking portion 8 is formed on the exterior of the terminal base 3 (not shown, for example, the fracture marking portion 8 shown in FIG. 17 switched to the terminal base 3).

Referring to FIG. 6 and FIG. 15 together, in some embodiments, the extension portion 11 has a first fillet 11a. The terminal base 3 has a second fillet 3a. The first fillet 11a is located at the wire outlet 14. The first fillet 11a and the second fillet 3a are respectively for contact by the connection terminal 91 of the coil 9, thus avoiding fracture caused by contact between the connection terminal 91 of the coil 9 and a non-arc surface.

Referring to FIG. 1 and FIG. 16 together, FIG. 16 is a schematic top view of the transformer 200, showing a state in which a single connection member 2 is removed. In some embodiments, the bobbin 100 includes a plurality of connection members 2 (or one connection member 2). One side of each of the connection members 2 is connected to two sides of the extension portion 11, and the other side of each of the connection members 2 is connected to two sides of the terminal base 3.

Referring to FIG. 16 and FIG. 17 together, FIG. 17 illustrates a schematic diagram of an appearance of the transformer 200 shown in FIG. 16, in which an extension portion 11 has a single fracture marking portion 8. In some embodiments, the bobbin 100 includes one connection member 2. After a cutting portion 21 of a used connection member 2 is cut off by the automated machining tool, a fracture marking portion 8 is formed on the exterior of the extension portion 11 (or a fracture marking portion 8 is formed on the exterior of the terminal base 3).

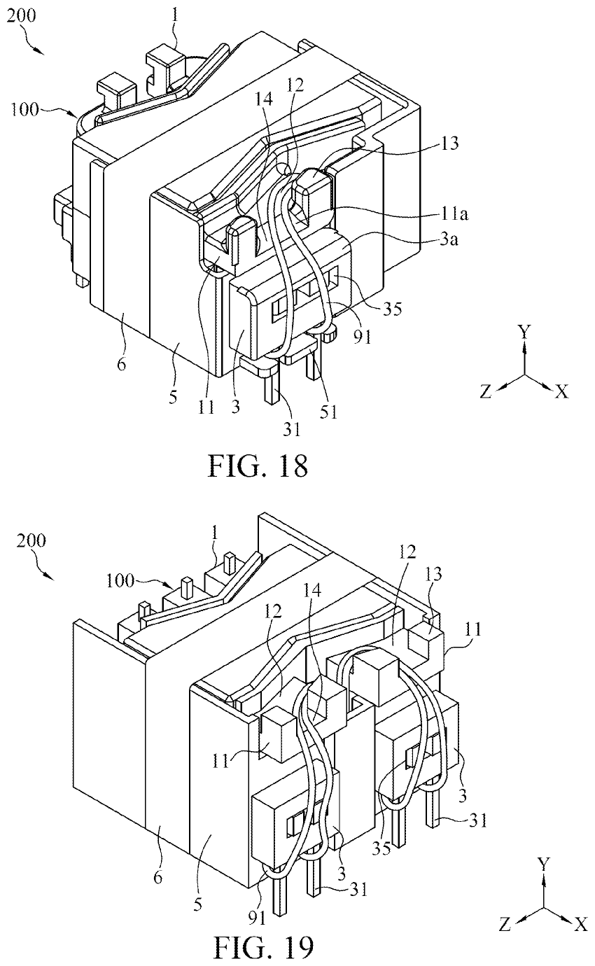

Referring to FIG. 1 and FIG. 18 together, FIG. 18 is a schematic diagram of the appearance of the transformer 200, in which a housing 5 has a terminal fixing member 51. In some embodiments, the housing 5 has the terminal fixing member 51. The terminal fixing member 51 is fixed to each of the pins 31. The terminal fixing member 51 is a clamping block 51 (the clamping block 51 is given by way of example below for description, and is given the same reference numeral as the terminal fixing member 51). The clamping block 51 has a plurality of recesses. Each of the pins 31 is snap-fitted into each of the recesses. The solder 92 (not shown) on each of the pins 31 is located between a top of the clamping block 51 and a bottom of the terminal base 3.

Referring to FIG. 1 to FIG. 19 together, FIG. 19 is a schematic diagram of an appearance of another transformer 200. In some embodiments, one side of the main body 1 has two extension portions 11 and two wire troughs 12. The coil 9 has four connection terminals 91. The bobbin 100 includes two terminal bases 3. Each of the terminal bases 3 includes two pins 31. The connection terminals 91 respectively extend out through the wire troughs 12 and are connected to the pins 31 in a one-to-one manner. In some embodiments, positions or a number of pins 31 of each of the terminal bases 3 may be adjusted as required, to match the configurations of the electronic parts on the circuit board. For example, only two connection terminals 91 are used, and only one pin 31 is left on each of the two terminal bases 3 for use. The two pins 31 of the two terminal bases 3 are respectively connected to the two connection terminals 91.

Referring to FIG. 20 to FIG. 22 together, FIG. 20 is a partial schematic side view of the transformer 200, in which the connection member 2 has a cutting portion 21. FIG. 21 is a partial schematic side view of the transformer 200, in which an assembling portion 55 and an engaging portion 35 both have an engaging member. FIG. 22 is a partial schematic side view of the transformer 200, in which one of the assembling portion 55 and the engaging portion 35 has an engaging member. In some embodiments, the connection member 2 has one cutting portion 21. The one cutting portion 21 is disposed adjacent to the terminal base 3 (which is shown in FIG. 20) or disposed adjacent to the main body 1 (which is shown in FIG. 21). Alternatively, the one cutting portion 21 is disposed at a central position between the terminal base 3 and the main body 1 (which is shown in FIG. 22). When the automated machining tool correspondingly cuts off the cutting portion 21 of the connection member 2, the cutting portion 21 of the connection member 2 fractures, so that the main body 1 is separated from the terminal base 3.

When the cutting portion 21 adjacent to the terminal base 3 is cut off, the connection member 2 located on the main body 1 is separated from the terminal base 3. When the cutting portion 21 adjacent to the main body 1 is cut off, the connection member 2 located on the terminal base 3 is separated from the main body 1. After the cutting portion 21 located at the central position between the terminal base 3 and the main body 1 is cut off, the connection member 2 is divided into two parts respectively located on the main body 1 and the terminal base 3. The connection member 2 which is cut into two parts is separated from the main body 1 and the terminal base 3.

Based on the above, according to some embodiments, after the connection member is removed through automated machining, the terminal base is mounted on the surface of the housing. An exterior of the transformer is mainly presented by a three-piece element: the housing, the bobbin, and the terminal base. Pins are provided on the terminal base for soldering of wires, and the housing has no pins, which effectively reduces the overall size of the transformer, thus achieving miniaturization, weight reduction, and portability of the transformer, and reducing manufacturing time and labor costs of the transformer. Secondly, according to some embodiments, the connection member between the main body of the bobbin and the terminal base that can be cut off through automated machining effectively increases efficiency of automated machining and a yield of the transformer.

What is claimed is:

1. A bobbin adapted to be wound by a coil, the bobbin comprising:
a main body, comprising an extension portion and a wire trough;
a connection member, wherein one side of the connection member is connected to the extension portion, and the connection member has a cutting portion; and
a terminal base, wherein the terminal base comprises a pin and is connected to the other side of the connection member,
whereby, a connection terminal of the coil extends to the terminal base through the wire trough and is connected to the pin.

2. The bobbin according to claim 1, wherein the main body, the connection member, and the terminal base is integrated in one piece made of a same material, and the connection member and the terminal base are arranged transversely on a side edge of the main body along a first axis.

3. The bobbin according to claim 1, wherein the connection member has two cutting portions, one of the cutting portions is disposed adjacent to the main body, and the other of the cutting portions is disposed adjacent to the terminal base.

4. The bobbin according to claim 1, further comprising a plurality of connection members, wherein one sides of the plurality of connection members are correspondingly connected to two sides of the extension portion, the other sides of the plurality of connection members are respectively connected to two sides of the terminal base, and the terminal base comprises two pins, whereby, the number of the connection terminal of the coil is two, the two pins are adapted to be respectively connected to the two connection terminals of the coil.

5. The bobbin according to claim 4, wherein the extension portion has a plurality of protrusions, and the main body has a wire outlet between the protrusions, whereby the connection terminals of the coil extend between the connection members via the wire outlet.

6. The bobbin according to claim 5, wherein the distance between the protrusions is less than the distance between the connection members.

7. The bobbin according to claim 5, wherein the extension portion has a first fillet, the terminal base has a second fillet, and the first fillet is located at the wire outlet, whereby the first fillet and the second fillet are adapted to respectively be contact with the coil.

8. The bobbin according to claim 1, wherein the number of the extension portion of the main body is two, the number of the wire troughs of the main body is two, and the main body has the two extension portions and the two wire troughs, whereby, the number of the connection terminal of the coil is four, the coil has the four connection terminals, the bobbin comprises two terminal bases, each of the terminal bases comprises two pins, and the four connection terminals correspondingly extend out through the wire troughs and are adapted to be correspondingly connected to the two pins of the terminal bases.

9. A transformer, comprising:
a housing;
a coil; and
a bobbin, comprising a main body, a connection member, and a terminal base, wherein the main body is wound by the coil and located in the housing, the main body has an extension portion and a wire trough, one side of the connection member is connected to the extension portion, the connection member has a cutting portion, the terminal base comprises a pin, the terminal base is connected to the other side of the connection member, a connection terminal of the coil extends to the terminal base through the wire trough and is connected to the pin; and the connection member and the terminal base are located outside the housing.

10. The transformer according to claim 9, wherein the connection member has two cutting portions, one of the cutting portions is disposed adjacent to the main body, and the other of the cutting portions is disposed adjacent to the terminal base.

11. The transformer according to claim 9, further comprising a plurality of connection members, wherein one sides of the plurality of connection members are correspondingly connected to two sides of the extension portion, the other sides of the plurality of connection members are connected to two sides of the terminal base, and the terminal base comprises two pins, whereby, the number of the connection terminal of the coil is two, the two pins are adapted to be respectively connected to the two connection terminals of the coil.

12. The transformer according to claim 9, wherein the connection member has two cutting portions, one of the cutting portions is disposed adjacent to the main body, and the other of the cutting portions is disposed adjacent to the terminal base, the transformer further comprises a plurality of connection members, one sides of the plurality of connection members are correspondingly connected to two sides of the extension portion, the other sides of the plurality of connection members are connected to two sides of the terminal base, and the terminal base comprises two pins, whereby, the number of the connection terminal of the coil is two, the two pins are adapted to be respectively connected to the two connection terminals of the coil.

13. A transformer, comprising:
a housing, comprising an assembling portion;
a coil; and
a bobbin, comprising a main body and a terminal base, wherein the main body is wound by the coil and located in the housing, the main body has an extension portion and a wire trough, the terminal base comprises a pin, a connection terminal of the coil extends to the terminal base through the wire trough and is connected to the pin, the terminal base comprises an engaging portion engaged with the assembling portion, and one of the extension portion and the terminal base has at least one fracture marking portion.

14. The transformer according to claim 13, wherein the fracture marking portion has a cutting plane or a cutting line.

15. The transformer according to claim 13, wherein one of the assembling portion and the engaging portion has an engaging member, and the terminal base is vertically arranged on a surface of the housing along a second axis.

16. The transformer according to claim 13, wherein the housing has a terminal fixing member, and the terminal fixing member is fixed to each of the pins.

17. The transformer according to claim 13, wherein the extension portion has one or more fracture marking portions, and the terminal base has one or more fracture marking portions.

18. The transformer according to claim 13, wherein the terminal base comprises two pins which are connected to two connection terminals of the coil in a one-to-one manner.

19. The transformer according to claim 13, wherein the number of the extension portion of the main body is two, the number of the wire troughs of the main body is two, and the main body has the two extension portions and the two wire troughs, whereby, the number of the connection terminal of the coil is four, the coil has the four connection terminals, the bobbin comprises two terminal bases, and each of the terminal bases comprises two pins, and the four connection terminals correspondingly extend out through the wire troughs and are adapted to be correspondingly connected to the two pins of the terminal bases.

20. The transformer according to claim 13, wherein the assembling portion has a plurality of hooks, the engaging portion has a hole, the hooks are snapped into the hole, the housing has a terminal fixing member, the terminal fixing member is fixed to each of the pins, the extension portion has one or more fracture marking portions, the terminal base has one or more fracture marking portions, and the terminal base comprises two pins, whereby, the number of the connection terminal of the coil is two, the two pins are adapted to be respectively connected to the two connection terminals of the coil.
